(19) United States
(12) Patent Application Publication
(10) Pub. No.: US 2010/0174722 A1
(43) Pub. Date: Jul. 8, 2010

(54) FILTERS FOR SHARED CONTENT IN AN ONLINE COMMUNITY

(75) Inventor: Francesco M. Carteri, Roma (IT)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/350,617

(22) Filed: Jan. 8, 2009

(51) Int. Cl. G06F 7/06; G06F 17/30

(52) U.S. Cl. 707/748; 707/E17.108

(57) ABSTRACT

Online communities publish vast quantities of video content. According to YouTube, an average of ten hours of media is posted to its website every minute. According to some embodiments of the inventive subject matter, an online community allows users to rate offensiveness of content and to apply filters to the content when the ratings indicate offensiveness is above a threshold. Filters can disturb or obscure offensive content so that it is less viewable. For example, a filter may be applied to an offensive video. The filter can blur the video's images and reduce the quality of sound associated with the video. In addition, warning may be applied to a link to content that indicates the offensiveness of the content. The filter and warning can provide a visual warning to users before they decide to access the content.

### BACKGROUND

Embodiments of the inventive subject matter generally relate to the field of online communities, and more particularly to applying visual filters to shared content in online communities.

Online communities, such as YouTube® and Wikipedia®, allow users to publish content that can be viewed by other users. Although online communities have rules to control posting of inappropriate or offensive (e.g., violent, sexually explicit, etc.) content, users may still post inappropriate content. If users are offended by certain content in an online community, they can report offensive content through interfaces of the online communities. The reports are sent to moderators who review the content. If the moderators determine that the content is inappropriate, the moderators typically manually remove the content.

### SUMMARY

Embodiments include a method directed to receiving, from a network browser, a request for content in an online community. Retrieving the content and a rating of the content from a database, wherein the rating indicates the overall offensiveness of the content based on user input. Determining a level of offensiveness of the content based on the rating. Applying a filter to the content based on the level of offensiveness. Transmitting the filtered content for presentation in the browser. Detecting a request to rate the content. Updating the rating of the content based on the request.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram of applying a filter to content in an online community.

FIG. 2 is a flowchart of example operations for applying a filter to content based on ratings.

FIG. 3 is an example conceptual diagram of a client applying a filter based on a rating of the content.

FIG. 4 is a flowchart depicting example operations for a client applying a filter based on a rating of the content.

FIG. 5 is an example conceptual diagram depicting a filter applied to an image.

FIG. 6 is an example conceptual diagram depicting a filter applied to an image.

FIG. 7 is a flowchart depicting example operations for updating a rating of content based on input from a user.

FIG. 8 depicts an example computer system.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to online communities, embodiments may be implemented in social networking sites. In other instances, well-known instruction instances, protocols, structures, and techniques have not been shown in detail in order not to obfuscate the description.

Online communities publish vast quantities of video content. According to YouTube, an average of ten hours of media is posted to its website every minute. According to some embodiments of the inventive subject matter, an online community allows users to rate offensiveness of content and to apply filters to the content when the ratings indicate offensiveness is above a threshold. Filters can disturb or obscure offensive content so that it is less viewable. For example, a filter may be applied to an offensive video. The filter can blur the video's images and reduce the quality of sound associated with the video. In addition, a warning may be applied to a link to content that indicates the offensiveness of the content. The filter and warning can provide a visual warning to users before they decide to access the content.

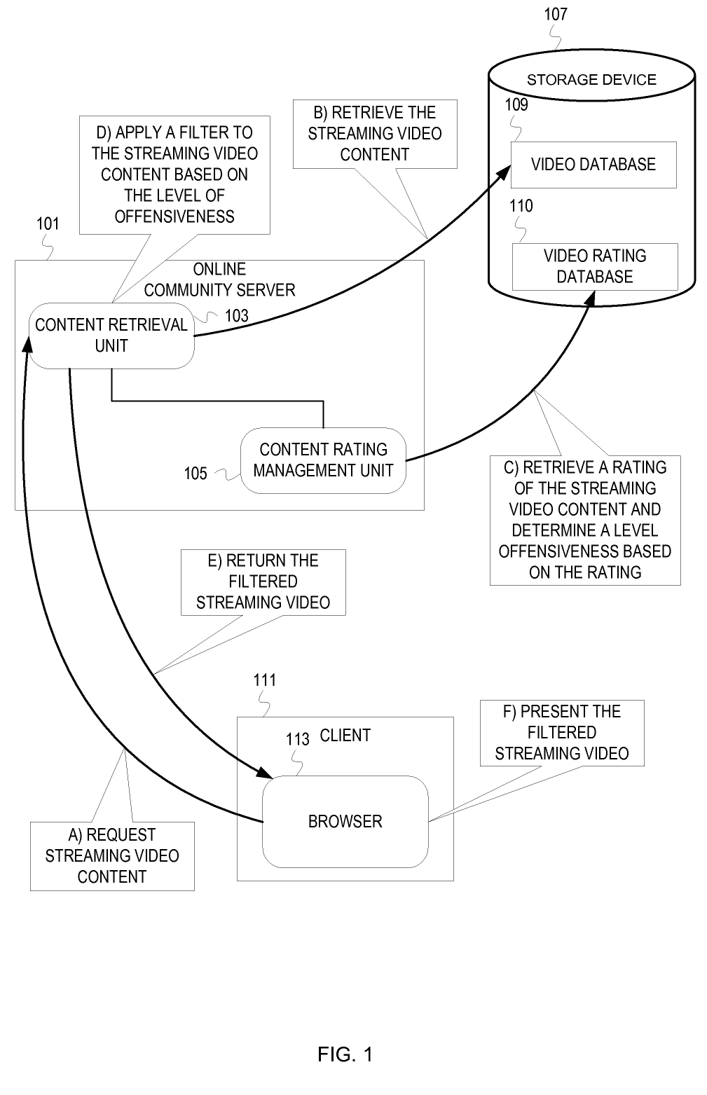

FIG. 1 is an example conceptual diagram of applying a filter to content in an online community. An online community server 101 comprises a content retrieval unit 103 and a content rating management unit 105. A browser 113 is running on a client 111. The client 111 may be a computer, a mobile phone, a personal digital assistant, etc. A storage device 107 comprises a video database 109 and a video rating database 110. Although not shown, the videos and ratings can reside in a single database. Also, the ratings can be included in the video files. Although the storage device 107 is depicted as a standalone device, the storage device may reside on the online community server 101, on another server, etc.

At stage A, the browser 113 requests streaming video content from the online community server 101. Other examples of content include an image, a text document, an audio file, etc.

At stage B, the content retrieval unit 103 retrieves the streaming video content from the video database 109.

At stage C, the content rating management unit 105 retrieves a rating of the streaming video content from the video rating database 110 and determines a level of offensiveness based on the rating. The rating is an indication of the overall offensiveness of the content and is determined based on user input. For example, the rating may be based on an average of a plurality of offensiveness scores submitted by users. The offensiveness scores can be based on a four point scale with point values being defined as 1—“not offensive”, 2—“mildly offensive”, 3—“moderately offensive”, and 4—“extremely offensive”. Determining the level of offensiveness is based on one or more thresholds. In the above example, there are four thresholds corresponding to each point value. In addition, the level of offensiveness may be based on a number of scores submitted by a plurality of users. For example, content may not be considered offensive until at least ten users have submitted offensiveness scores.

At stage D, the content retrieval unit 103 applies a filter to the streaming video content based on the level of offensiveness. The filter obscures offensive content so that it is less viewable. Examples of applying filters include superimposing a pattern over the streaming video content, blurring the streaming video content, removing pixels from the streaming video content, decreasing quality of sound, etc. Different filters may be applied to content based on different levels of offensiveness. Referring to the example of the four-point scale, no filter would be applied to streaming video content with an average rating below three. A sparse pattern of lines may be superimposed over the streaming video for an average rating above three and below four. A dense pattern of lines may be superimposed over the streaming video for an average rating above four.

At stage E, the content retrieval unit 103 returns the filtered streaming video to the browser 113.

At stage F, the browser 113 presents the filtered streaming video.

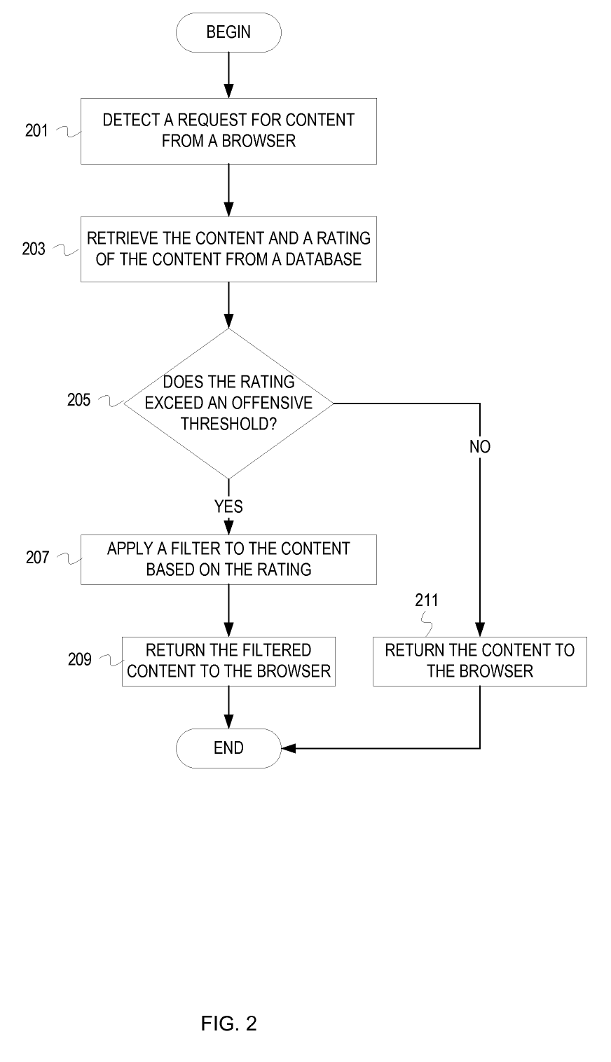

FIG. 2 is a flowchart of example operations for applying a filter to content based on ratings. Flow begins at block 201 where an online community server detects a request for content from a browser. Examples of content include a video, an image, a webpage, an audio file, a document, etc. Flow continues at block 203.

At block 203, a content retrieval unit retrieves the content and a rating of the content from a database. The database may be hosted on the online community server, on another server, on a network drive, etc. In some embodiments, the rating can be based on a number of times the content was reported as offensive by a plurality of users. In some instances, as described above, users can rate content according to a numerical scale (e.g., from one to four). After a certain number of users rate the content above a particular number on the scale, the content may be “offensive content.” Flow continues at block 205.

At block 205, a content rating management unit determines if the rating exceeds a threshold. For example, the threshold is exceeded if more than 1000 offensive reports have been submitted for the content (e.g., 1000 users rate the content 4 on a scale of 1-4). In some embodiments, the content exceeds the threshold under other conditions, such as when a single user assigns the content a certain rating. If the rating exceeds the threshold, flow continues at block 207. If the rating does not exceed the threshold, flow continues at block 211.

At block 207, the content retrieval unit applies a filter to the content (e.g., a video) based on the rating. Examples of applying filters include superimposing a pattern over the content, superimposing text over the content, blurring the content, removing pixels from the content, etc. Flow continues at block 209.

At block 209, the content retrieval unit returns the filtered content to the browser and flow ends.

At block 211, the rating does not exceed the threshold, so the content retrieval unit returns the content to the browser and flow ends.

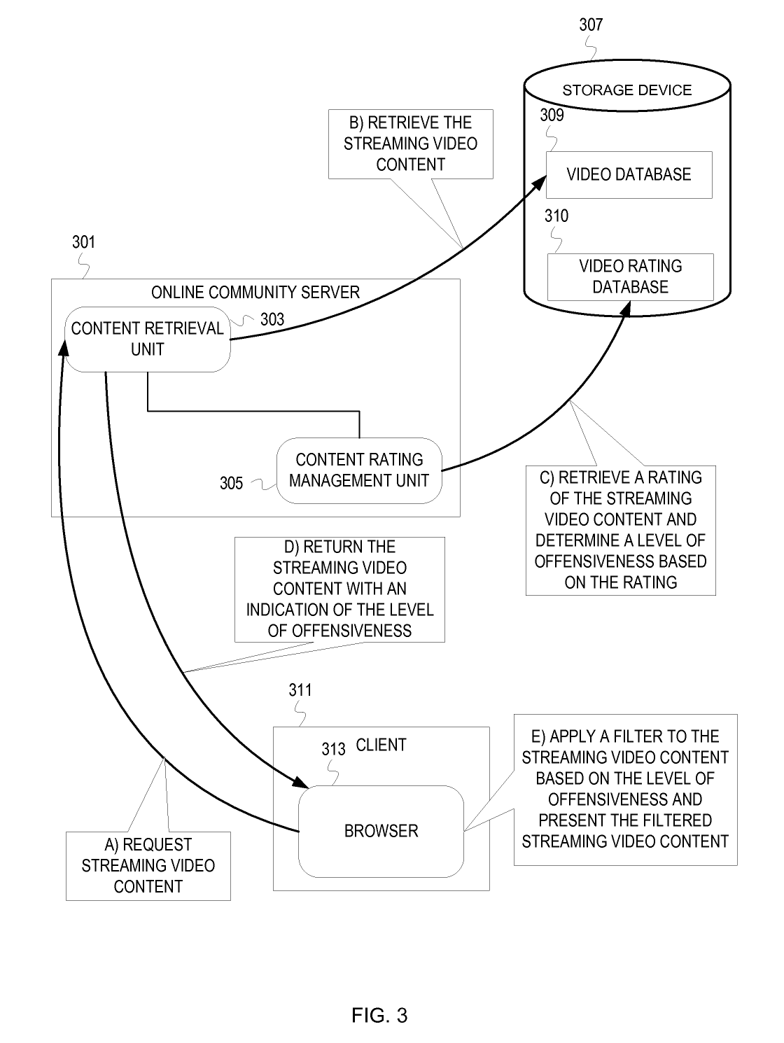

A filter may be applied to content by a server or a client. In the previous examples, the filter was applied to the content by an online community server. FIG. 3 is an example conceptual diagram of a client applying a filter based on a rating of the content. An online community server 301 comprises a content retrieval unit 303 and a content rating management unit 305. A browser 313 is running on a client 311. The client 311 may include a computer, a mobile phone, a personal digital assistant, etc. A storage device 307 comprises a video database 309 and a video rating database 310. Although the storage device 307 is depicted as a standalone device, the storage device may be on the online community server 301, on another server, etc.

At stage A, the browser 313 requests content from the online community server 301. In this example, the content is a streaming video.

At stage B, the content retrieval unit 303 retrieves the streaming video content from the video database 309.

At stage C, the content rating management unit 305 retrieves a rating of the streaming video content from the video rating database 310 and determines a level of offensiveness based on the rating. For example, the level of offensiveness is based on the number of times the steaming video has been reported as offensive.

At stage D, the content retrieval unit 303 returns the streaming video content with an indication of the level of offensiveness.

At stage E, the browser applies a filter to the streaming video content based on the level of offensiveness and presents the filtered streaming video content. For example, the browser blurs the streaming video content and reduces sound quality.

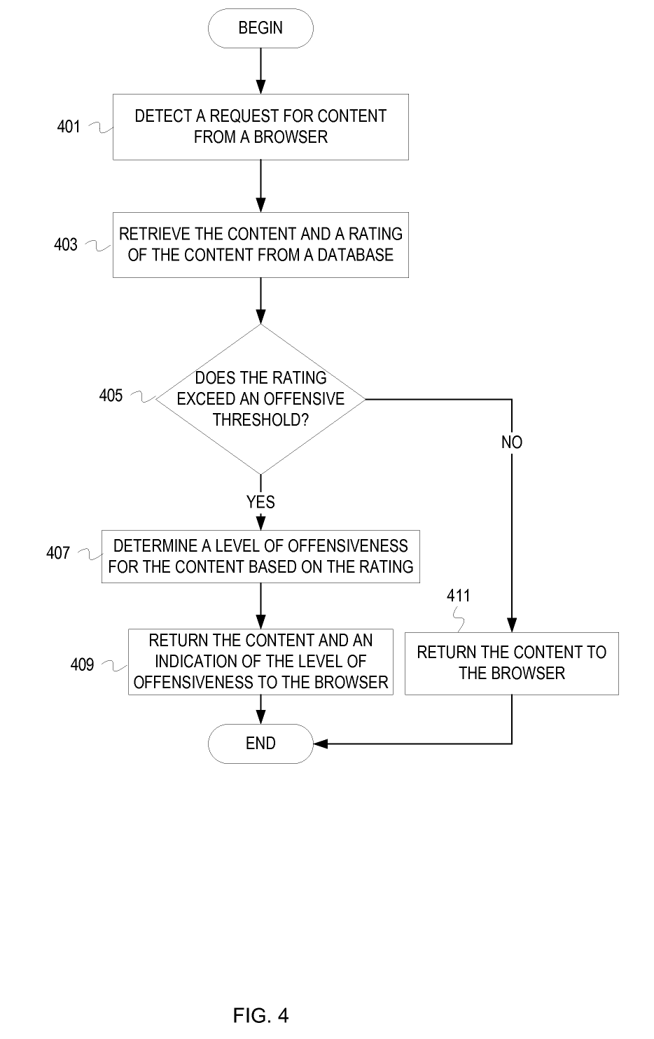

FIG. 4 is a flowchart depicting example operations for a client applying a filter based on a rating of the content. Flow begins at block 401 where an online community server detects a request for content from a browser. For example, the request is for an image. Flow continues at block 403.

At block 403, a content retrieval unit retrieves the content and a rating of the content from a database. Flow continues at block 405.

At block 405, a content rating management unit determines if the rating exceeds a threshold. For example, each user rates the content on a ten-point scale. The rating can be an average of all of the user ratings. The threshold may be seven (or any other suitable number), so if the rating is equal to or greater than seven, a filter is applied. If the rating exceeds the threshold, flow continues at block 407. If the rating does not exceed the threshold, flow continues at block 411.

At block 407, the content rating management unit determines a level of offensiveness based on the rating. As an example, the content rating management unit determines a level of offensiveness based on the ten-point scale. Flow continues at block 409.

At block 409, the content retrieval unit returns the content and an indication of the level of offensiveness to the browser and flow ends. In response, the browser applies a filter to the content based on the level of offensiveness and presents the filtered content. Preferences may indicate how the filter is applied to the content. The preferences may be specified by the content rating management unit. For example, the content rating management unit indicates the filter to apply to the content based on the level of offensiveness. The preferences may be specified by a user of the browser. For example, a user who is not easily offended specifies that filters should be applied to content with high levels of offensiveness. The user can also specify attributes of the filters (e.g., density of superimposed patterns, percentage of pixels to be removed, etc.). As another example, a user who has children can specify that filters should be applied to all content that may be offensive.

At block 411, the rating does not exceed the threshold, so the content retrieval unit returns the content to the browser and flow ends. In response, the browser presents the content without a filter.

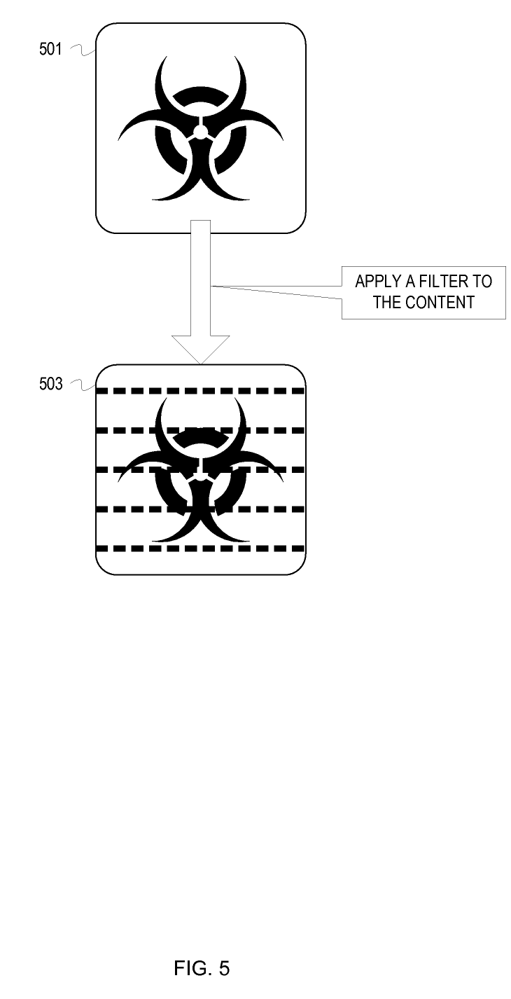

FIG. 5 is an example conceptual diagram depicting a filter applied to an image. Content 501 comprises an image with a rating. A filter is applied to the content 501 based on the rating. The filter may be applied by an online community server or by a browser on a client. In this example, the filter is a pattern of dotted lines superimposed over the image. The filter partially obscures the image. Content 503 comprises the filtered image.

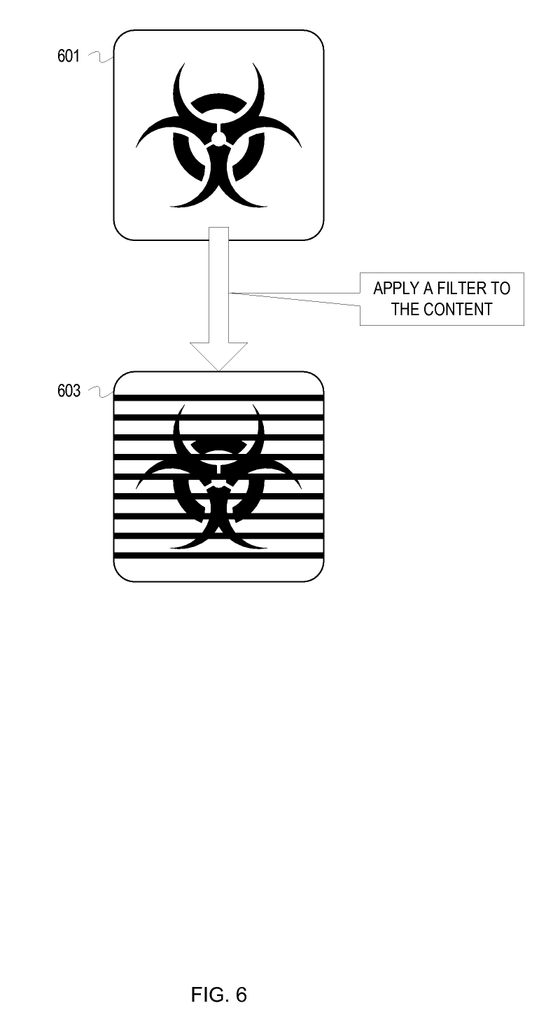

FIG. 6 is an example conceptual diagram depicting a filter applied to an image. Content 601 comprises an image with a rating. A filter is applied to the content 601 based on the rating. The filter may be applied by an online community server or by a browser on a client. In this example, the filter is a pattern of solid lines superimposed over the image. The filter partially obscures the image. Content 603 comprises the filtered image.

In FIGS. 5 and 6, content 603 is more obscured than content 503. This is due to content 601's rating being considered more offensive than content 503's rating. As noted above, the filter can obscure the image by blurring, removing pixels, superimposing text, etc.

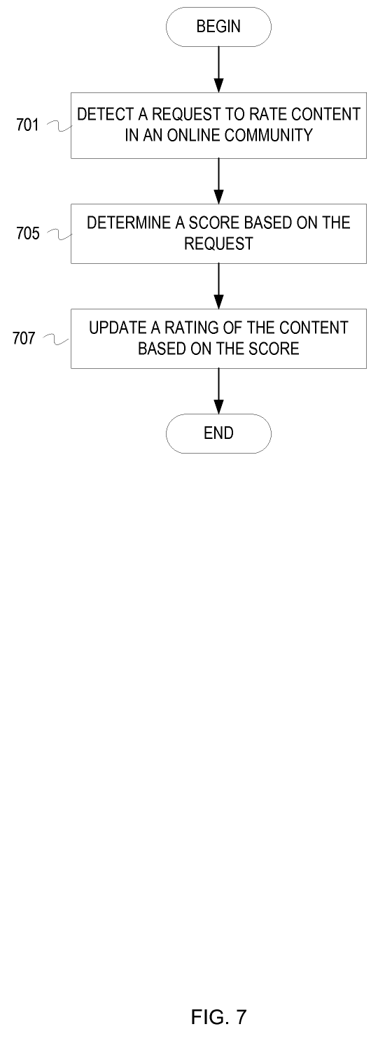

FIG. 7 is a flowchart depicting example operations for updating a rating of content based on input from a user. Flow begins at block 701, where a content rating management unit detects a request to rate content in an online community. For example, the content management unit detects that a user has submitted a report indicating that he or she considered the content to be offensive. Flow continues at block 705.

At block 705, the content rating management unit determines a score based on the request. For example, a user indicates the score by clicking a radio button corresponding one of two options, “offensive” or “not offensive.” In some instances, a positive score is associated with the “not offensive” option, whereas a negative score is associated with the “offensive” option. Flow continues at block 707.

At block 707, the content rating management unit updates a rating of the content based on the score and flow ends. The rating may be a sum of positive and negative scores (e.g., if the rating is positive, the content is not offensive), an average of scores determined from a scale, a number of times the content has been reported as offensive, etc.

In addition to applying filters to content based on a level of offensiveness, content may be subject to removal from the online community based on the level of offensiveness. For example, a moderator may be notified when a rating exceeds a certain threshold. In response, the moderator removes the content from the online community. As another example, the content may be removed from the online community automatically by the content rating management unit when the rating exceeds a certain threshold.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. Furthermore, the computer program code includes machine instructions native to a particular processor. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

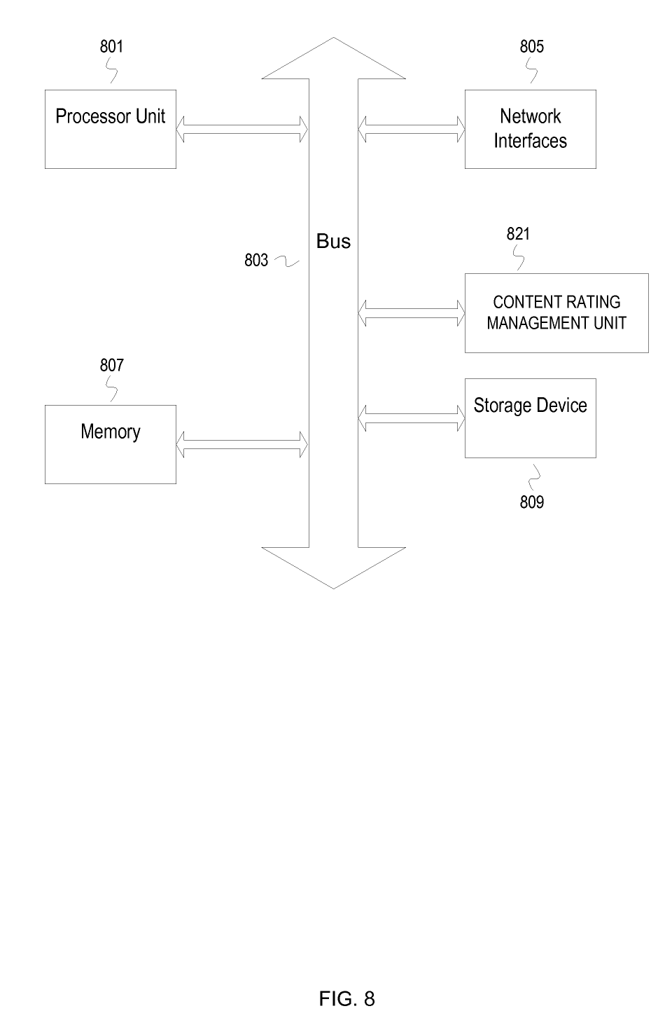

FIG. 8 depicts an example computer system. A computer system includes a processor unit 801 (possibly including multiple processors, multiple cores, multiple nodes, and/or implementing multi-threading, etc.). The computer system includes memory 807. The memory 807 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 803 (e.g., PCI, ISA, PCI-Express, HyperTransport®, InfiniBand®, NuBus, etc.), a network interface 805 (e.g., an ATM interface, an Ethernet interface, a Frame Relay interface, SONET interface, wireless interface, etc.), and a storage device(s) 809 (e.g., optical storage, magnetic storage, etc.). The computer system also comprises a content rating management unit 821 that determines a rating of requested content in an online community, determines a level of offensiveness based on the rating and applies a filter to the requested content based on the level of offensiveness. The content rating management unit 821 also determines that a score should be applied to the content and updates the rating based on the score. Any one of these functionalities may be partially (or entirely) implemented in hardware and/or on the processing unit 801. For example, the functionality may be implemented with an application specific integrated circuit, in logic implemented in the processing unit 801, in a co-processor on a peripheral device or card, etc. Further, realizations may include fewer or additional components not illustrated in FIG. 8 (e.g., video cards, audio cards, additional network interfaces, peripheral devices, etc.). The processor unit 801, the storage device(s) 809, and the network interface 805 are coupled to the bus 803. Although illustrated as being coupled to the bus 803, the memory 807 may be coupled to the processor unit 801.

While the embodiments are described with reference to various implementations and exploitations, it will be understood that these embodiments are illustrative and that the scope of the inventive subject matter is not limited to them. In general, techniques for automatically applying a visual filter to shared contents in an online community as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A computer-implemented method for electronically filtering content, the method comprising:
receiving, from a network browser, a request for content in an online community;
retrieving the content and a rating of the content from a database, wherein the rating indicates the overall offensiveness of the content based on user input;
determining a level of offensiveness of the content based on the rating;
applying a filter to the content based on the level of offensiveness;
transmitting the filtered content for presentation in the browser;
detecting a request to rate the content; and
updating the rating of the content based on the request.

2. The method of claim 1, wherein the content comprises, at least one of, a video, an image, a webpage, an audio file and a document.

3. The method of claim 1, wherein said determining a level of offensiveness of the content based on the rating further comprises determining if the rating exceeds one or more thresholds, wherein the one or more thresholds represent one or more maximum values for the rating.

4. The method of claim 1, wherein the rating comprises, at least one of, a sum of positive or negative values, an average of a plurality of scores determined from a scale, and a number of times the content has been reported as offensive.

5. The method of claim 1, wherein said applying a filter to the content based on the level of offensiveness further comprises, at least one of, superimposing a pattern over the content, superimposing text over the content, blurring the content, removing pixels from the content and decreasing quality of the content.

6. The method of claim 1, wherein said applying a filter to the content based on the level of offensiveness is performed by, at least one of, an online community server, and a client running the browser.

7. The method of claim 1, wherein updating the rating of the content based on the request further comprises determining an offensiveness score based on the request, wherein the offensiveness score is submitted by a user to rate the offensiveness of the content.

8. One or more machine-readable media having stored therein a program product, which when executed by a set of one or more processor units causes the set of one or more processor units to perform operations that comprise:
receiving, from a network browser, a request for content in an online community;
retrieving the content and a rating of the content from a database, wherein the rating indicates the overall offensiveness of the content based on user input;
determining a level of offensiveness of the content based on the rating;
applying a filter to the content based on the level of offensiveness;
transmitting the filtered content for presentation in the browser;
detecting a request to rate the content; and
updating the rating of the content based on the request.

9. The machine-readable media of claim 8, wherein the content comprises, at least one of, a video, an image, a webpage, an audio file and a document.

10. The machine-readable media of claim 8, wherein said determining a level of offensiveness of the content based on the rating further comprises determining if the rating exceeds one or more thresholds, wherein the one or more thresholds represent one or more maximum values for the rating.

11. The machine-readable media of claim 8, wherein the rating comprises, at least one of, a sum of positive or negative values, an average of a plurality of scores determined from a scale, and a number of times the content has been reported as offensive.

12. The machine-readable media of claim 8, wherein said applying a filter to the content based on the level of offensiveness further comprises, at least one of, superimposing a pattern over the content, superimposing text over the content, blurring the content, removing pixels from the content and decreasing quality of the content.

13. The machine-readable media of claim 8, wherein said applying a filter to the content based on the level of offensiveness is performed by, at least one of, an online community server, and a client running the browser.

14. The machine-readable media of claim 8, wherein updating the rating of the content based on the request further comprises determining an offensiveness score based on the request, wherein the offensiveness score is submitted by a user to rate the offensiveness of the content.

15. An apparatus comprising:
a set of one or more processing units;
a network interface; and
a content rating management unit operable to,
receive, from a network browser, a request for content in an online community;
retrieve the content and a rating of the content from a database, wherein the rating indicates the overall offensiveness of the content based on user input;
determine a level of offensiveness of the content based on the rating;
apply a filter to the content based on the level of offensiveness;
transmit the filtered content for presentation in the browser;
detect a request to rate the content; and
update the rating of the content based on the request.

16. The apparatus of claim 15, wherein the content comprises, at least one of, a video, an image, a webpage, an audio file and a document.

17. The apparatus of claim 15, wherein said the content rating management unit being operable to determine a level of offensiveness of the content based on the rating further comprises the content rating management unit being operable to determine if the rating exceeds one or more thresholds, wherein the one or more thresholds represent one or more maximum values for the rating.

18. The apparatus of claim 15, wherein the rating comprises, at least one of, a sum of positive or negative values, an average of a plurality of scores determined from a scale, and a number of times the content has been reported as offensive.

19. The apparatus of claim 15, wherein said the content rating management unit being operable to apply a filter to the content based on the level of offensiveness further comprises the content rating management unit being operable to, at least one of, superimpose a pattern over the content, superimpose text over the content, blur the content, remove pixels from the content and decrease quality of the content.

20. The apparatus of claim 15, wherein said the content rating management unit being operable to update the rating of the content based on the request further comprises the content rating management unit being operable to determine an offensiveness score based on the request, wherein the offensiveness score is submitted by a user to rate the offensiveness of the content.
